(19) United States
(12) Patent Application Publication
(10) Pub. No.: US 2004/0189590 A1
(43) Pub. Date: Sep. 30, 2004

(54) Human machine interface for a compressor system

(75) Inventors: James D. Mehaffey, Mooresville, NC (US); Robert J. Dameron, Charlotte, NC (US); Paul A. Kirkpatrick, Charlotte, NC (US); Alfred Paul Venancio III, Charlotte, NC (US)

Correspondence Address: David B. Smith, Michael Best & Friedrich LLP, Suite 360, 3773 Corporate Parkway, Center Valley, PA, 18034, US

(73) Assignee: Ingersoll-Rand Company, Woodcliff Lake, NJ (US)

(21) Appl. No.: 10/397,134

(22) Filed: Mar. 26, 2003

(51) Int. Cl. G09G 5/00

(52) U.S. Cl. 345/156

(57) ABSTRACT

A human machine interface for an air pressure system. The interface may include a processor and a display device, and is operable to display one or more interface screens including a graphical representation of a pressure system and system configuration screens. The interface is also operable to display one or more system parameters and allow user input for configuring and scheduling machine operating sequence, pressure events, operating points, and alarms.

### FIELD OF THE INVENTION

The present invention relates to methods and systems for controlling one or more compressors in a multiple compressor environment. More particularly, embodiments of the invention relate to a human machine interface for use with an air pressure control system.

### BACKGROUND OF THE INVENTION

Compressed air is often utilized for a variety of functions including transporting materials, operating industrial machinery, and actuating pneumatic power tools. Typically, a compressed air system operates by actuating, or driving, one or more compressors to supply air into a holding tank, in a manner that is similar to the way that a well-pump feeds water into a reservoir. Because air is compressible, the air supplied by the compressors may be pressurized to a relatively high level. One aspect of a properly functioning compressed air system is that the holding tank maintains a pressure that is higher than the pressure demanded by any machines or tools to which it is connected.

In some facilities, a compressor controller may be implemented to monitor a system based on a demand cycle. If the demand for compressed air is steady and does not fluctuate, a compressor control system may simply match air capacity to the system demand. However, in many instances, multiple devices may be connected to a compressed air system at different times and throughout the day. As a result, the system air demand may fluctuate depending on the processes, breaks, shift changes, etc. In addition, because most facilities use multiple compressors, an opportunity for savings exists in the efficient control of these multiple unit systems.

One form of compressor flow control is inlet throttling where the physical size of a compressor inlet opening is reduced to limit the incoming air flow and, therefore, the pressurized output. However, inlet throttling is not satisfactory in complex systems, which typically include multiple compressors that must respond to sporadic demand cycles. Existing systems for controlling multiple compressor systems often have electro-pneumatic controllers. This type of controller may be implemented by over-lapping the control pressure range of the compressors such that compressors go on-line and off-line in a cascade-style manner. A series of mechanical trip switches may be utilized to discontinue compressor operation when pressures or temperatures reach critical levels. However, electro-pneumatic systems are generally limited in that the cascade-style configuration provides little flexibility for compressor sequencing. Moreover, measurement accuracy of system quantities may be difficult with existing controllers. Temperature and pressure switches used with original equipment manufacturer (“OEM”) other electro-pneumatic controllers may drift and change set-points with time. For example, the air pressure signal for an OEM pressure controller is typically taken from within the compressor package. This signal is often not sensing actual system pressure and may not compensate for the pressure drop that may occur within the compressor package.

In addition to the above limitations, the use of variable speed drive (“VSD”) compressors in a multiple compressor system often presents challenges for system controllers. VSD compressors typically operate independent of a system controller or, in some cases, a controller operates the VSD compressors as if they were fixed speed compressors. In either mode of operation, an operator is usually required to monitor and adjust the operating pressures of the VSD compressors to match the operating pressure of the system. As a result, the VSD compressors may react to each other instead of the system demand. Moreover, most current systems lack the ability to automatically change the system operating pressure.

### SUMMARY OF THE INVENTION

Accordingly, a need exists for a method and system for controlling one or more compressors by a controller capable of integrating user configurations and generating compressor-specific and compensated pressure commands to affect efficient control of system pressure.

In one embodiment, the invention provides a system for controlling one or more compressors and includes a controller, one or more sensors operable to sense pressure, and where the controller includes an interface having a display device. The controller is operable to communicate with each of the compressors, receive data from the sensors and the interface, and communicate system parameters to the display device. In addition, the controller is operable to modify the operation of the compressors in response to user input and in response to data received from the sensors. The system compensates for pressure drops between the compressor output and a system output and the controller generates pressures commands for each compressor to compensate for the pressure drop. Further, the system may be configured to allow sequencing, event, and alarm configurations.

In other embodiments, the invention provides a human machine interface (“HMI”) for a pressure system having a processor and a display device. The HMI is operable to display one or more interface screens including screens for configuring system parameters, a graphical representation of a machine, a passage, a connection between the machine and the passage, a tank, a connection between the passage and the tank, and a tank output. In addition, the HMI is operable to display a plurality of dynamic indicators and one or more system parameters including a system pressure and a machine status. Further, the HMI allows user input for machine and system configuration including events, sequences, alarm levels, and others. Additional features of the invention are provided in the subsequent disclosure.

### BRIEF DESCRIPTION OF THE DRAWINGS

FIG. 1 illustrates exemplary components of a computer for use with embodiments of the invention.

FIG. 2 illustrates an exemplary system according to one embodiment of the invention.

FIG. 3 illustrates an exemplary configuration of a host controller according to one embodiment of the invention.

FIG. 4 illustrates an exemplary configuration of an interface according to one embodiment of the invention.

FIG. 5 illustrates steps in an exemplary process according to one embodiment of the invention.

FIG. 6A illustrates an exemplary system according to one embodiment of the invention.

FIG. 6B illustrates an exemplary table of pressure command calculations according to one embodiment of the invention.

FIG. 7 illustrates an exemplary system status screen according to one embodiment of the invention.

FIG. 8 illustrates an exemplary machine status screen according to one embodiment of the invention.

FIG. 9 illustrates an exemplary set points screen according to one embodiment of the invention.

FIG. 10 illustrates an exemplary pressure setup screen according to one embodiment of the invention.

FIG. 11 illustrates an exemplary pressure control screen according to one embodiment of the invention.

FIG. 12 illustrates an exemplary sequence setup screen according to one embodiment of the invention.

FIG. 13 illustrates an exemplary sequence rotation screen according to one embodiment of the invention.

FIG. 14 illustrates an exemplary timed sequence screen according to one embodiment of the invention.

FIG. 15 illustrates an exemplary event sequence screen according to one embodiment of the invention.

FIG. 16 illustrates an exemplary manual sequence screen according to one embodiment of the invention.

FIG. 17 illustrates an exemplary clock setup screen according to one embodiment of the invention.

FIG. 18 illustrates an exemplary dew point setup screen according to one embodiment of the invention.

FIG. 19 illustrates an exemplary external flow screen according to one embodiment of the invention.

FIG. 20 illustrates an exemplary external flow setup screen according to one embodiment of the invention.

FIG. 21 illustrates an exemplary external pressure event screen according to one embodiment of the invention.

FIG. 22 illustrates an exemplary system configuration screen according to one embodiment of the invention.

FIG. 23 illustrates an exemplary initialize set points screen according to one embodiment of the invention.

FIG. 24 illustrates an exemplary language screen according to one embodiment of the invention.

FIG. 25 illustrates an exemplary units setup screen according to one embodiment of the invention.

FIG. 26 illustrates an exemplary access code screen according to one embodiment of the invention.

FIG. 27 illustrates an exemplary service contact information screen according to one embodiment of the invention.

FIG. 28 illustrates an exemplary compressor setup screen according to one embodiment of the invention.

FIG. 29 illustrates an exemplary log summary screen according to one embodiment of the invention.

FIG. 30 illustrates an exemplary event log screen according to one embodiment of the invention.

FIG. 31 illustrates an exemplary alert history screen according to one embodiment of the invention.

FIG. 32 illustrates an exemplary active alerts screen according to one embodiment of the invention.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

Before embodiments are described in detail, it should be noted that the invention is not limited to any particular software language described or implied in the figures. One of skill in the art will understand that a variety of alternative software languages may be used for implementation of the invention.

It should also be understood that some components and items are illustrated and described as if they were hardware elements, as is common practice within the art. However, one of ordinary skill in the art, and based on a reading of this detailed description, would understand that, in at least one embodiment, components comprised in the method and system, such as an interface, may be implemented in software.

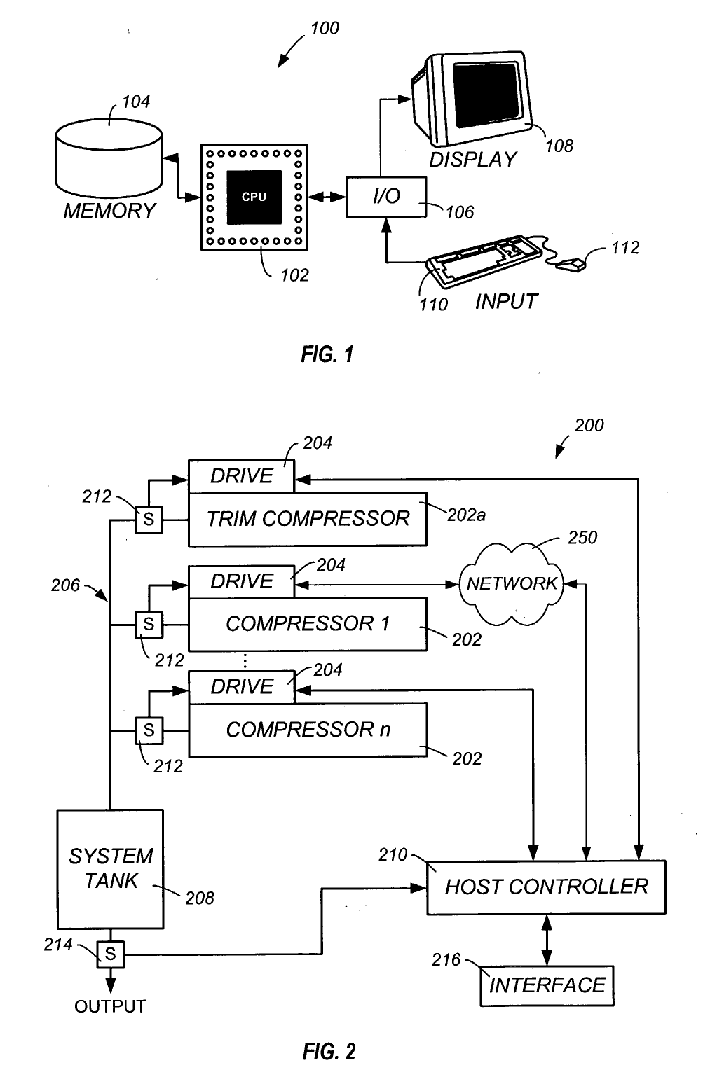

Referring to FIG. 1, embodiments of the invention may be implemented using one or more components of a conventional computer, such as the computer 100. The computer 100 includes a central processing unit (“CPU”) or processor 102, a memory or data storage device 104, an input/output device 106, a display device 108, and a plurality of input devices including a keyboard 110 and/or a mouse 112. One should note that the terms “memory” and “data storage device” are herein used generically to mean either or both volatile and non-volatile data storage, such as a random access memory (“RAM”), a hark disk drive, tape storage, ROM, EPROM, and other storage media. In general, the exemplary computer 100 may include a variety of other known elements (voice recognition components, additional drives, peripherals, etc.) and software (operating system software, application software, utilities, etc.), and is not limited to the components or configuration illustrated in FIG. 1.

FIG. 2 illustrates one embodiment of an exemplary system 200 with multiple compressors 202, such as fixed speed and VSD compressors. One skilled in the art will understand that a plurality of types of compressors may be implemented with the invention including, but not limited to, various configurations of reciprocating, centrifugal, and rotary-based compressors. In addition, although embodiments of the invention are described for use with pneumatic systems, the teachings disclosed herein may be extended to pump-based hydraulic systems and other types of process control applications. For example, the invention may be implemented to control belt tension for torque disturbances in a multi-servo conveyor system. In the illustrated example, the compressors 202 shown in FIG. 2 are VSD compressors that are coupled to separate drives 204, which are operable to control the speed of the compressors 202. In general, the term “drive” is used generically to encompass any electronic components or control circuitry or software coupled to a machine (e.g., a compressor, pump, or other motor) and operable to change operating characteristics including, for example, machine speed and direction. With respect to compressors, one or more of the compressors 202 may be designated as a trim compressor 202a (described below). The output of the compressors 202 feeds through a passage 206, which is common to the output of each compressor 202, and eventually into a system tank 208. When processes, tools, or machinery (not shown) require pneumatic power, the system 200 responds to the air pressure demand by extracting compressed air from the system tank 208. Subsequently, the compressors 202 respond to the reduction in system tank 208 air pressure by operating to reestablish and maintain a pressure set point. To provide the required air pressure control, the drives 204 that govern the compressors 202 are coupled to a controller, such as a host controller 210. The host controller 210 is operable to perform multiple functions including receiving and/or transmitting data from/to the drives 204, one or more discharge pressure transducers or sensors 212, one or more system pressure transducers or sensors 214, and an interface 216. The discharge sensors 212 may be located near an output of each compressor such that a discharge or output air pressure measurement is possible. The system sensor 214 may be located near an output of the system tank and operable to measure system output pressure, or system pressure. Information from the discharge sensors 212 and the system sensor 214 may be communicated to the host controller 210 and utilized in determining output commands (described below). One should note that a variety of pressure transducers from multiple manufactures may be utilized with the invention to provide pressure based information. In some embodiments, the host controller 210 is coupled to an interface 216 that may be utilized for user or operator input, system configurations, and displaying system information. It should be noted that the interface 216 may include hardware and software linked or in communication with the host controller 210. In addition, the host controller 210 and interface 216 may include software routines written using one or more of a variety of programming languages and libraries, for example C, C++, Java, and GTK-based components. The software may be configured to run on an operating system including Linux, Windows CE, Pocket PC, or other Unix and Windows-based systems.

In the embodiment shown in FIG. 2, data from the discharge sensors 212 is communicated to the drives 204. Therefore, one configuration of the system 200 includes a two-way communication path between the drives 204 and the host controller 210. In this manner, the drives 204 and host controller 210 may be configured to share pressure and speed command based data using one of a plurality of known data transmission protocols. In other embodiments, pressure-based sensor data may be transferred directly to the host controller 210, and command-based data from the host controller 210 may be relayed to the drives 204 using one-way communication paths. It should be noted that the terms “communication,” “communications,” “transfer,” “path,” “link,” and combinations or variations thereof are used generically to encompass one-way or two-way data and information exchange.

It should also be noted that data transfer or communication between components of the system 200 is not limited to a hard-wired configuration. One example is illustrated in FIG. 2. FIG. 2 illustrates a network 250, which may be implemented using wireless-based and network-based communication techniques and equipment. Examples of alternative communications networks suitable for use in embodiments of the invention include optical communications, local area networks (“LANs”), wide area networks (“WANs”), the Internet, an Intranet, and metropolitan area networks (“MANs”).

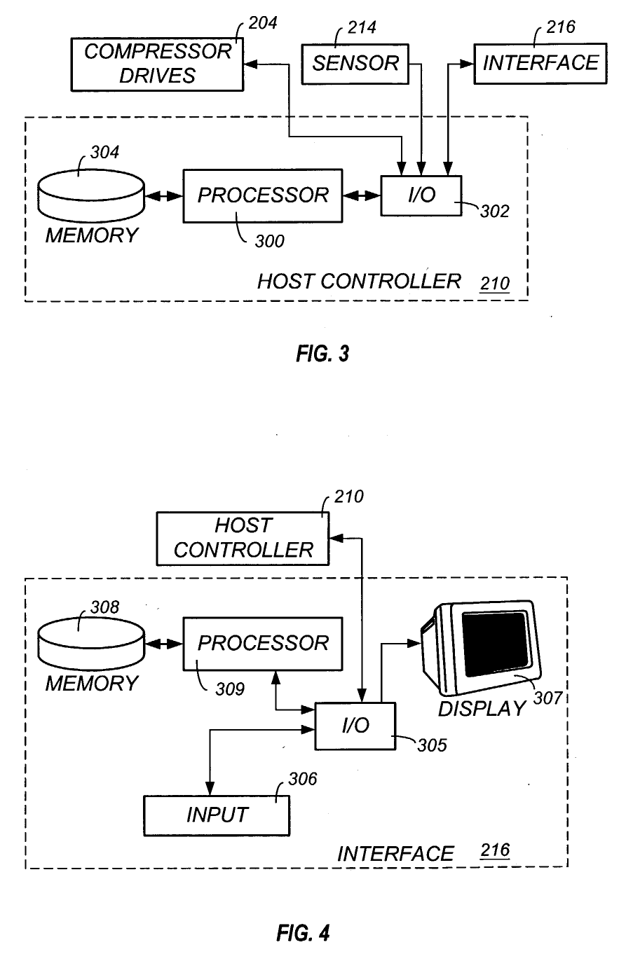

FIG. 3 illustrates an exemplary configuration of the host controller 210 that includes a processor 300, an input/output (“I/O”) device 302, and a memory or data storage device 304. A plurality of devices may be implemented as the processor 300 including 16 bit or higher microprocessors and micro-controllers from multiple manufacturers including Intel Corporation, Philips Semiconductor, National Semiconductor, and many others. The I/O device 302 of the host controller 210 may be configured to receive information from the sensor 214, the interface 216, and drives 204. The information may include pressure data from the discharge of each compressor or the system tank 208 (FIG. 2) and user input information such as pressure set points. The memory 304 may be coupled to the processor 300 and include various types of volatile and non-volatile memory, such as random access memory (“RAM”) read only memory (“ROM”). In some embodiments, the memory 304 may be implemented to store data representing pressure information, user preferences, set points, historical data such as system pressure fluctuations over a period of time, command data, or the like. The host controller 210 may include multiple instances of, and alternatives to, the components illustrated in FIG. 3.

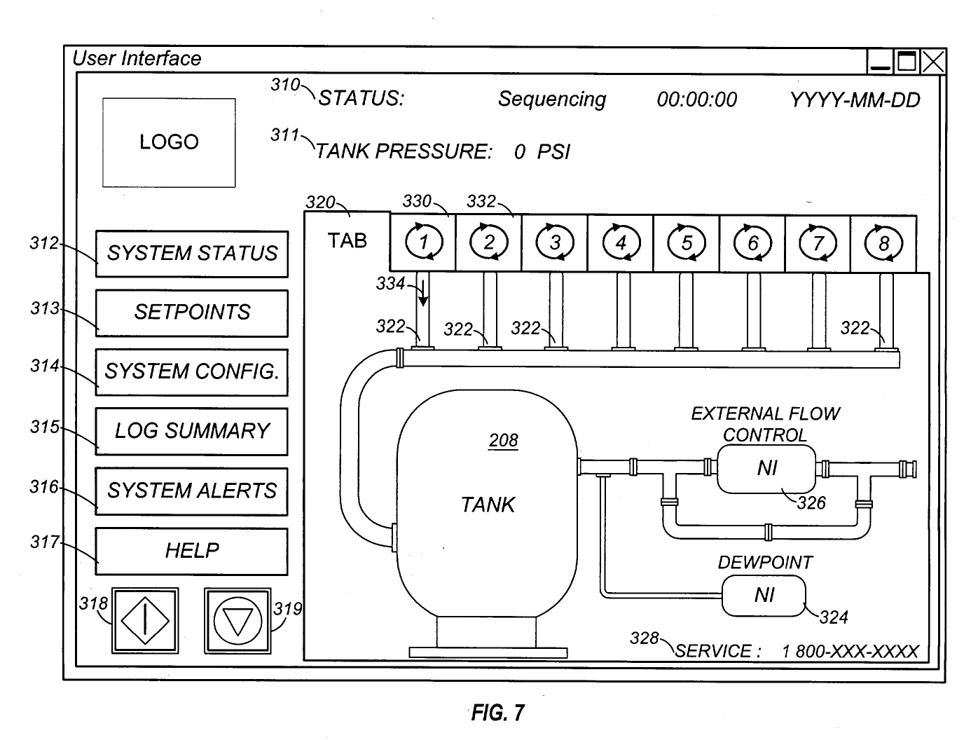

One embodiment of the interface 216 is illustrated in FIG. 4 and has components similar to the exemplary computer 100 (FIG. 1). In the embodiment of FIG. 4, an I/O device 305 is coupled to the host controller 210. As noted, the connections illustrated in the drawings may include various types of wired or wireless couplings or connections such that information may be communicated therebetween. An input mechanism 306 may include multiple input devices, such as a keyboard and mouse (like those shown in FIG. 1), a touch sensitive display (not shown), a voice input device (not shown), or many others. The display 307 is operable to present one or more interface screens to the user including those illustrated in FIGS. 7-32. It should be noted that FIG. 4 illustrates only one embodiment of the invention where the interface 216 includes components similar to computer 100 and is separate from the host controller 210. In other embodiments, the host controller 210 may include a display and input means, such as the display 307 and the input mechanism 306, coupled to the I/O device 302 such that the interface 216 is integrated in the host controller 210. One skilled in the art will understand that the invention may be implemented with the interface 216 and host controller 210 as separate devices, as shown in FIGS. 3 and 4, or by integrating the two, as described above.

In one embodiment of the invention, the host controller 210 may be implemented to control a single compressor 202 that may or may not be part of a multiple compressor system. In this embodiment, and as noted above, the single controlled compressor 202 may be designated as a trim compressor 202a (FIG. 2).

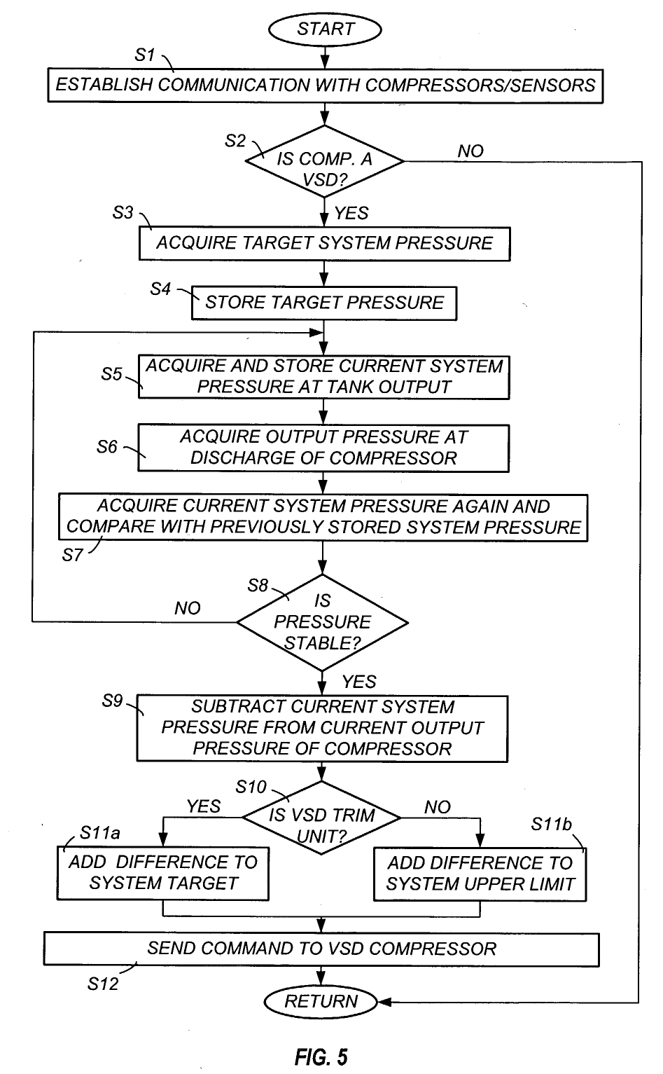

FIG. 5 illustrates the steps of an exemplary process that may be at least partially executed by the processor 300 of the host controller 210 to provide control of a single compressor 202 in a multiple compressor system, such as system 200. Specifically, the exemplary process begins (step S1) with the host controller 210 performing one or more operations to establish a communication path with the drive 204, the compressor 202, or both (depending on compressor type and configuration), the discharge sensor 212, and the system sensor 214. In some embodiments, the drives and sensors may be hard-wired to the host controller 210 and communication paths may already be established. The host controller 210 determines (step S2) whether the compressor currently communicating with the host controller 210 is a VSD compressor 202. If the compressor is not a VSD compressor 202, subsequent operations are skipped and the program “returns” to check the next compressor 202. The host controller 210 may loop through the connected compressors until a VSD compressor 202 is located. Upon locating a VSD compressor 202, the host controller 210 may acquire (step S3) a target system pressure (“TSP”) or operating point from user input information received from the interface 216, and store (step S4) that information in memory. The memory may include memory 304, 308, or another memory device such as a temporary device or buffer including random access memory (“RAM”), a shift register, or the like. In addition, the TSP may be previously stored in memory, such as memory 304 or 308, and the host controller 210 may retrieve it therefrom.

A current system pressure (“CSP”) is acquired (step S5) from information received from the system sensor 214, and a current output pressure (“COP” the VSD compressor 202 is requested and communicated (step S6) to the host controller 210. The COP is based on data sensed by the discharge sensor 212 of the VSD compressor 202 and, as noted above, may be communicated to the host controller 210 using one or more types of communication links or transmission protocols. Although not illustrated, the COP and CSP data may be stored permanently or temporarily in one or more storage devices including memory 304. The host controller 210 acquires (step S7) a new CSP and compares this value to the previously stored CSP to determine the stability of the CSP. The stability may be determined by calculating a differential in CSP measurements and comparing the differential to a set tolerance. If the differential is greater than the set tolerance (i.e., not stable as determined at step S8), the CSP values are repeatedly acquired (steps S5-S7) until the comparison between the two CSP values yields a value or result that is not changing excessively with time (i.e., within the acceptable tolerance).

When the pressure is determined to be stable, the CSP is subtracted (step S9) from the COP of the VSD compressor 202. In some embodiments, and as described in more detail below, the difference between the CSP and the COP is used when determining the commands for each compressor in the system 200 and may be stored in memory as described above. The host controller queries (step S10) the VSD compressor 202 to establish whether the VSD compressor 202 is the trim VSD compressor 202a. The trim VSD compressor 202a may be designated as such using a variety of indicators such as an electronic identification communicated from the drive 204, software flags or other variable definitions, a user input designation, or the like. In one embodiment, a single VSD compressor 202 serves as the trim compressor 202a. It should be noted that the functionality associated with the trim compressor 202a may be implemented using any one of the VSD compressors 202 in the multiple compressor system 200.

Referring again to FIG. 5, if the VSD compressor 202 is the trim compressor 202a, the pressure command is determined by adding (step S11a) the pressure differential (between the CSP and COP) to the TSP. This command value is then communicated (step S12) to the drive 204 of the trim compressor 202a. If the VSD compressor is not the trim compressor 202a, the pressure command is determined by adding (step S11b) the pressure differential to the upper limit of the host controller's TSP. The pressure command is then communicated (step S12) to the drive 204 of the VSD compressor 202. The pressure commands for the compressors 202 account for pressure drops or increases in the system 200 between the discharge of each compressor and the output of the system tank 208 (FIG. 2). The upper limit of the host controller's TSP may be the pressure limit at which the host controller begins removing compressors 202 from operation. The compressor 202 may receive command pressures that are at or slightly above the upper pressure limit of the host controller so that they operate at nearly 100% capacity throughout the pressure band. The compressors 202 will not slow down until the CSP is above the host controller's acceptable limit or bandwidth. This helps keep compressors 202 from reacting to each other or to the trim compressor 202a. In addition, with only one compressor serving as a trim compressor, only one VSD compressor 202 adjusts its speed around the host controller's TSP. The above-described process may repeatedly execute in a loop-type fashion and react to changes occurring in the system 200. For example, if the system 200 includes filters that become clogged and are changed periodically, the system pressure may fluctuate. If the host controller 210 determines that the pressure drop between the VSD compressor 202 and the system output has changed, it will repeat the above process to determine the pressure commands for the trim compressor 202a and the other VSD compressor 202.

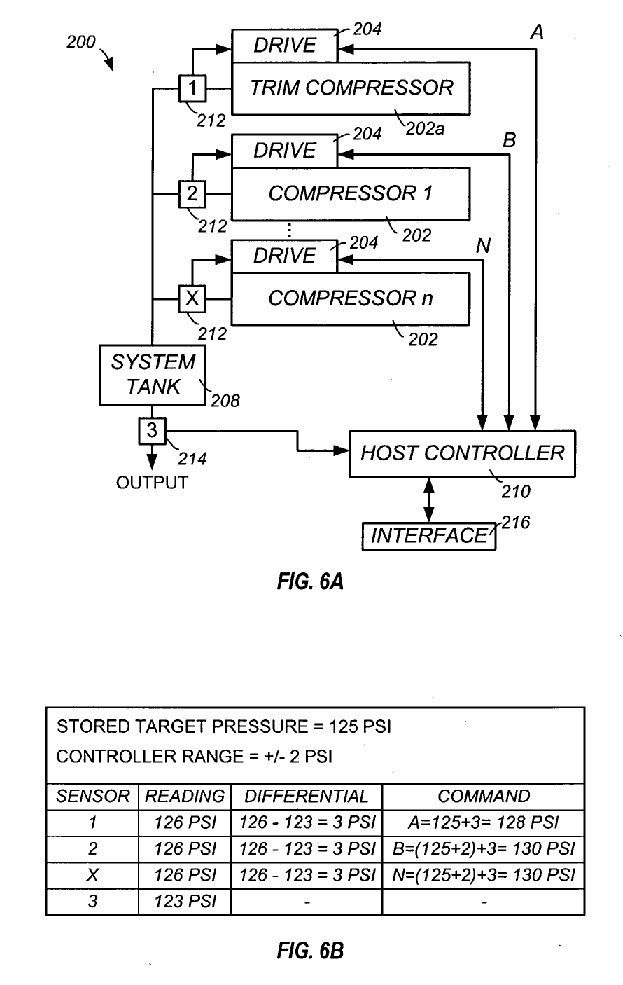

FIGS. 6A and 6B are provided to further illustrate a process of determining a command pressure. More specifically, FIG. 6A illustrates a multiple compressor system 200 with sensors 212 labeled 1, 2, and X, for sensing the COP of each compressor 202 and a sensor 214 labeled “3” for sensing the CSP. In addition, pressure commands communicated to the drives 204 from the host controller 210 are labeled A, B, and N. FIG. 6B includes exemplary pressure command calculations for the system illustrated in FIG. 6A and according to the above-described steps. The numbers used in FIG. 6B are arbitrary and provided only to further the readers understanding of the steps involved in determining pressure commands in one embodiment of the invention. In the example provided, the stored target pressure is 125 pounds per square inch (“psi”) the controller range, or bandwidth is +/−2 psi. The COP value is retrieved for each compressor and, for this example, equals 126 psi. If the CSP value is measured at 123 psi, then the difference between the COP and CSP is 3 psi. Following step S11a described above, the pressure command A, for the trim compressor 202a, is calculated to equal 128 psi. Following step S11b, the pressure command B through N is calculated to equal 130 psi or, in other words, the sum of the stored target pressure at the upper limit value (125+2) and the 3 psi pressure difference.

As noted above, information may be communicated between the host controller 210 and the interface 216. In one embodiment, the interface 216 includes a display, such as the display 307 (FIG. 4) for presenting the user with one or more interface screens such as those illustrated in FIGS. 7-32. One should note that the screens illustrated in the drawings are exemplary and not to be considered limiting in content or configuration. In addition, one skilled in the art will understand that a variety of software tools and operating systems may be used to realize the interface 216 and that embodiments of the invention may implement a subset of, additional, or alternative interface screens.

One exemplary interface screen is illustrated in FIG. 7 and includes a status field 310 that, in one embodiment, indicates information such as the current time, date, and whether the host controller 210 is currently sequencing the system 200. The term sequencing may be used herein to mean the general control of the system 200, and the compressors coupled to the system 200, including loading and unloading compressors, generating pressure commands, and monitoring systems parameters such as set points, alerts, pressure events, and many others. A tank pressure field 311 indicates the current pressure in the system tank 208 (FIG. 2) and a plurality of buttons are included for selection by the user. In the example shown, the buttons include a system status button 312, a set-points button 313, a system configuration button 314, a log summary button 315, a system alerts button 316, a help button 317, a sequence start button 318, and a sequence stop button 319. Selection of the sequence start and stop buttons 318 and 319 may be used to respectively initiate and terminate host controller 216 operations and also to modify the status field 310. Selecting one of the other above-noted buttons may result in the display of one or more additional interface screens. It should be noted that, in general, the terms “select,” “choose,” “input,” “enter,” and variations thereof are used in general to mean interaction or actuation with or by a user to invoke a process or provide information to the system 200. For example, selecting buttons, tabs, and populating data fields may be accomplished using a variety of tools including a conventional keyboard, a mouse, a keypad, a finger or stylus sensitive touch-screen or pad, and/or voice commands.

Referring again to FIG. 7, selection of the system status button 312 presents the user with a graphical representation of the compressor connections in the system 200. This representation is provided as part of a status tab 320 and includes a representation of feed-pipes or discharge pipes 322, from each of the compressors 202 in the system 200, and their common connection to the system tank 208. The output of the system tank 208 is depicted as being connected to an optional dew-point sensor 324 and an external flow controller 326. In addition, a service number 328 may be provided for user reference. In one embodiment, the discharge pipes 322 illustrated in the status tab 320 are connected to graphical representations of the compressors 202. Specifically, each discharge pipe 322 is associated with a indicator tab, such as tab 330, which includes a numerical indication of the associated compressor 202 and an active or operating indicator, such as the circular arrows 332. For example, when compressor 1, indicated by tab 330, is operating, the arrows 332 may rotate. In addition, a second graphical indicator may indicate when a compressor 202 is providing air through the discharge pipe 322 to the system tank 208. For example, when compressor 202 indicated by tab 330, hereinafter referred to as “compressor 1,” is providing air into the system 200, the arrow 334 moves along the representation of the discharge pipe 322 to indicate air production. One of ordinary skill in the art will understand that the use of rotating arrows 332 and arrow 334 are exemplary and that other graphical or audible indications, such as colors, other shapes, or sounds, may be implemented for use with the interface 216. In addition, FIG. 7 illustrates eight compressors 202 coupled to the system 200. However, additional or a subset of compressors 202 may be coupled to the system 200 both physically and graphically. In one embodiment, the status tab 320 allows an operator to monitor the system 200 and view which compressors 202 are running and contributing air to the system tank 208. In addition and as described in detail below, the tabs 330 representing compressors 202 may change colors and blink thereby indicating a warning or error. For example, yellow and red color changes may be used to respectively distinguish a warning and an error.

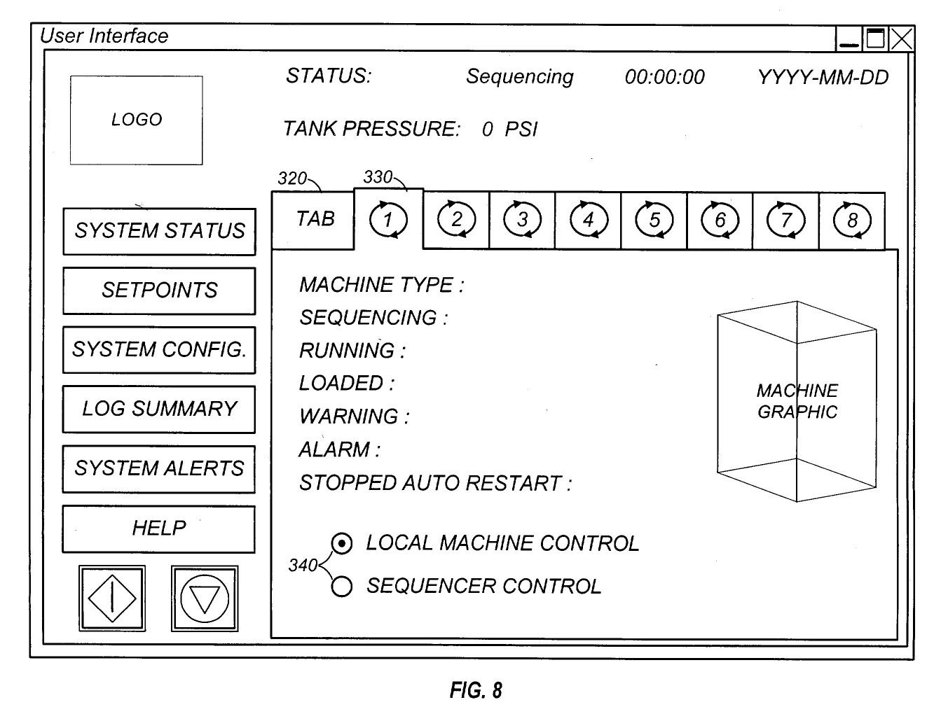

When a warning or error occurs, or when it is desired to view the status of a compressor 202, the user or operator may select the desired tab 330 for a detailed view of the attributes associated with that compressor 202. FIG. 8 illustrates an exemplary interface screen for the selection of compressor 1. The screen includes multiple compressor 202 attributes, such as the compressor or machine type, whether or not it is sequencing, running, or loaded, warnings, alarms or alerts, and whether the machine was auto-restarted. It should be noted that the terms “load,” “unload,” and variations thereof are used generically to encompass the conditions in which a compressor is or is not providing air to the system, respectively. The operator may select one of the buttons 340 to indicate whether the compressor 202 is associated with the sequencing control provided by the host controller 210 or with a local machine control. In one embodiment, the status tab 320 of FIG. 7 is provided with a miniature representation of the interface screen such that a user viewing a compressor tab 330 will have a visual indication of a previously selected screen.

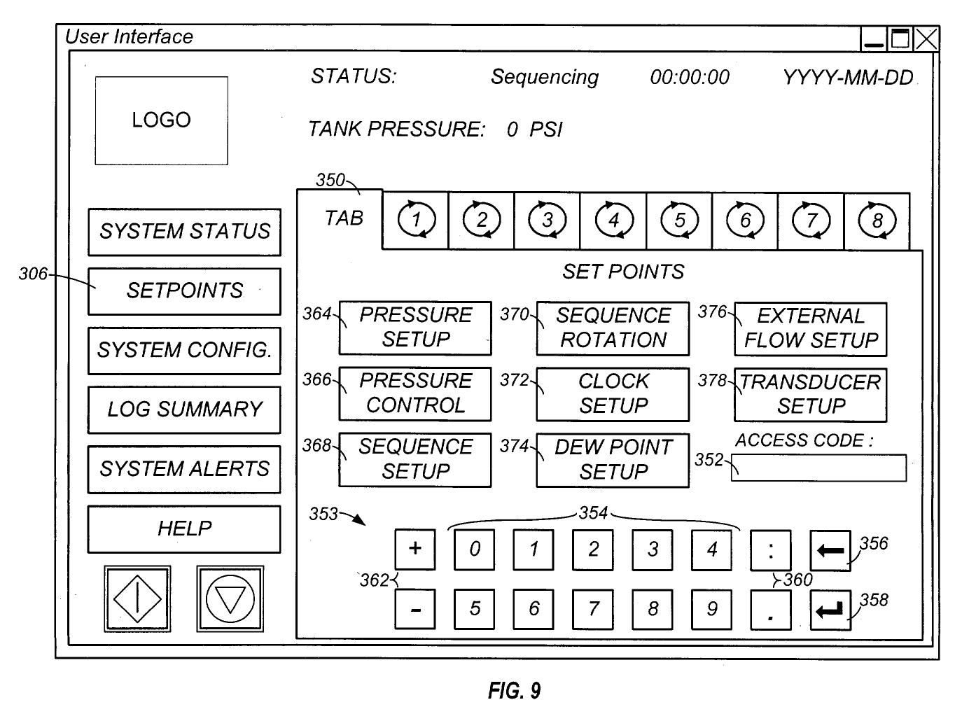

FIG. 9 illustrates selection of the set-points button 313 and resulting set-points tab 350. The tab 350 includes an access-code field 352 that, in one embodiment, may be used as a security feature to authorize user access. In other embodiments, different access codes may be given for different levels of authorized access or, if desired, the access code feature may be deactivated entirely. A graphical keypad (shown generally at 353) may be included with many of the interface screens to provide a method of input field population, such as populating the access-code field 352, and may include numeric buttons 354, a backspace or delete button 356, an enter button 358, punctuation buttons 360, and increment/decrement buttons 362. In addition, the set-points tab 350 includes menu buttons such as a pressure setup button 364, a pressure control button 366, a sequence setup button 368, a sequence rotation button 370, a clock setup button 372, a dew-point setup button 374, an external-flow button 376, and a transducer setup button 378. As described in more detail below, selection of the above-noted buttons presents the user with one or more additional interface screens.

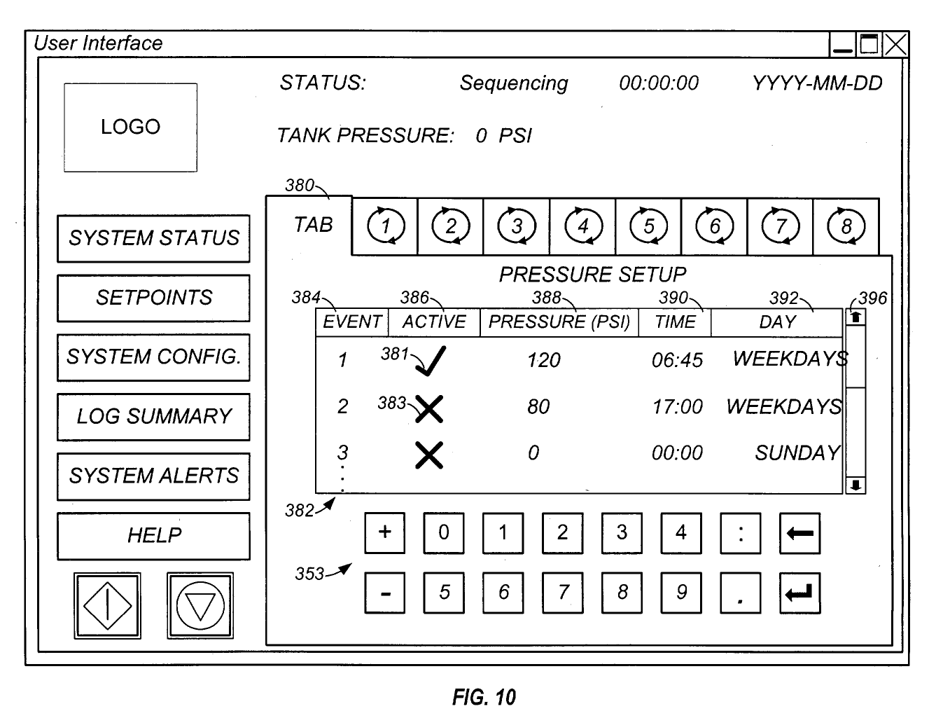

Selection of the pressure setup button 364 yields the screen illustrated in FIG. 10. A displayed pressure tab 380 includes the above-described graphical keypad 353 and a setup window 382 including an event field 384, an active field 386, a pressure field 388, a time field 390, and a day field 392. The setup window 382 may be scrolled to view additional events using, for example, the scroll bar 396 or another known scrolling technique. In one embodiment, active and inactive events appear with an indicator, such as check 381 or an “X” 383, respectively. The pressure field 388 may be chosen by the user and corresponds to the TSP described above. The time field 388 and day field 390 allow the user to schedule automatic changes in TSP for which the host controller 210 will add or remove (e.g., load or unload) compressors 202 in an attempt to meet the scheduled pressure event. In the example provided in FIG. 10, the TSP is set to 120 psi every weekday at 6:45 am and, unless commanded otherwise, the host controller 210 works to maintain that pressure until 5:00 pm each day, at which time the TSP reduces to 80 psi and remains there until 6:45 am the next weekday. Further, because Saturday and Sunday are not considered weekdays and no other events are active, the TSP would reduce to 80 psi on Friday at 5:00 pm and remain at that level until 6:45 am Monday morning. One should note that the day field 392 may be populated with other recurrence indicators, such as a single day, weekly, monthly, weekends, and so on.

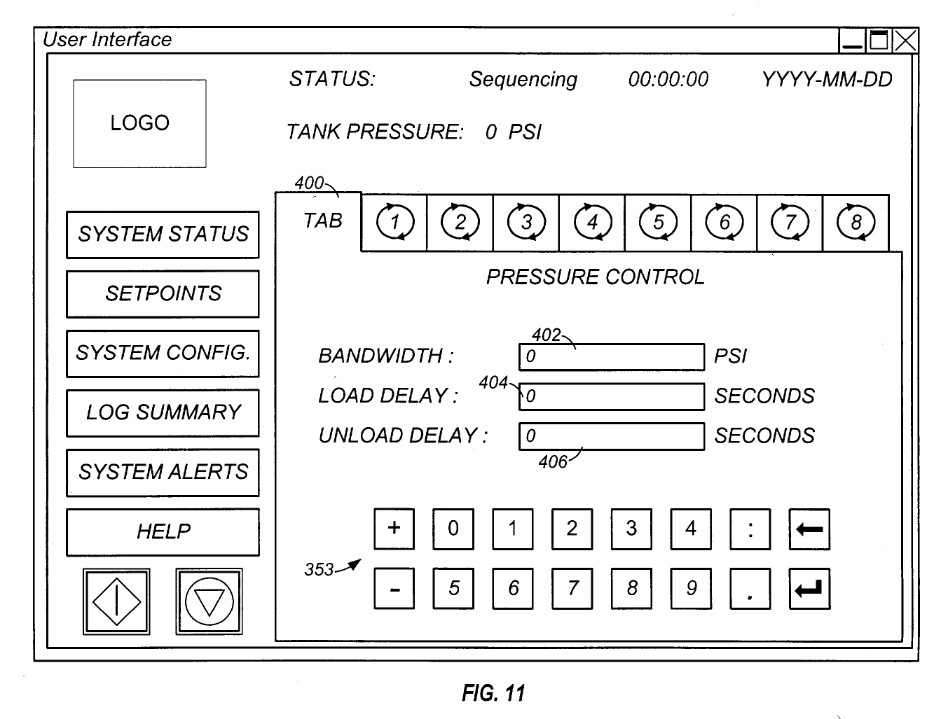

As illustrated in FIG. 11, a control tab 400 may be displayed upon selection of the pressure control button 366 (FIG. 9). The control tab 400 includes the graphical keypad 353 and multiple input fields, such as a bandwidth field 402, a load-delay field 404, and an unload-delay field 406. In one embodiment, input to the bandwidth field 402 indicates a pressure range, centered around the TSP, within which the host controller 210 will command the trim compressor 202a to speed up and slow down according to the sensed pressure fluctuations. For example, if the entered bandwidth is 6 psi and the TSP is 100 psi, the host controller will not load additional compressors 202 in the sequence until the CSP drops below 97 psi and will not unload additional compressors 202 in the sequence until the CSP rises above 103 psi. As noted, within the bandwidth, the trim compressor 202a is controlled for smaller pressure fluctuations and if the pressure rises or falls outside of the bandwidth, the host controller 210 first examines the state of the trim compressor 202a to determine if it is already at maximum or minimum speed. If the host controller determines that the trim compressor 202a has fully reacted to the pressure fluctuation and the pressure is still outside the bandwidth, additional compressors in the entered sequence are loaded or unloaded after the load or unload delay period, respectively. In one embodiment, the delayed loading and unloading feature of the invention may be used to prevent multiple compressors from loading simultaneously and, therefore, reducing power consumption and pressure spikes. By utilizing the bandwidth value, load delay, and unload delay, the host controller 210 is operable to reduce pressure fluctuations using a minimal number of compressors 202.

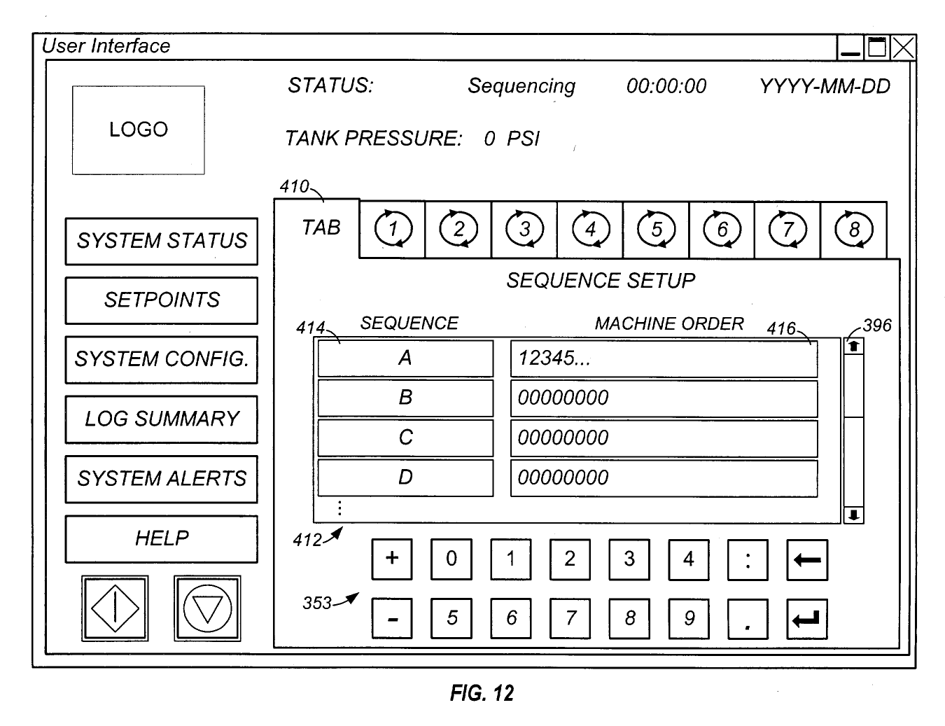

Referring to FIG. 9, selection of the sequence setup button 368 may yield a screen illustrated in FIG. 12 including a sequence tab 410 that includes the graphical keypad 353 and a sequence window 412. In one embodiment, the sequence window 412 includes a column of sequence indicators 414, shown generically as alphabetical letters “A,” “B,” and the like, and corresponding machine input fields 416. Although the FIG. 12 illustrates four possible sequences, additional sequence indicators 414 and machine input fields 416 may be viewed using, for example, the scroll bar 396. Inputs to the machine input fields 416 correspond to a desired sequence of compressor 202 usage. For example, FIG. 12 illustrates sequence A as including compressors numbers 1, 2, 3, 4, 5, and so on. These numbers correspond to the compressor tabs 330 and associated compressors 202. Similarly, sequence B, C, D, and so on may be other desired combinations or ordered sequences of compressors 202 coupled to the system 200.

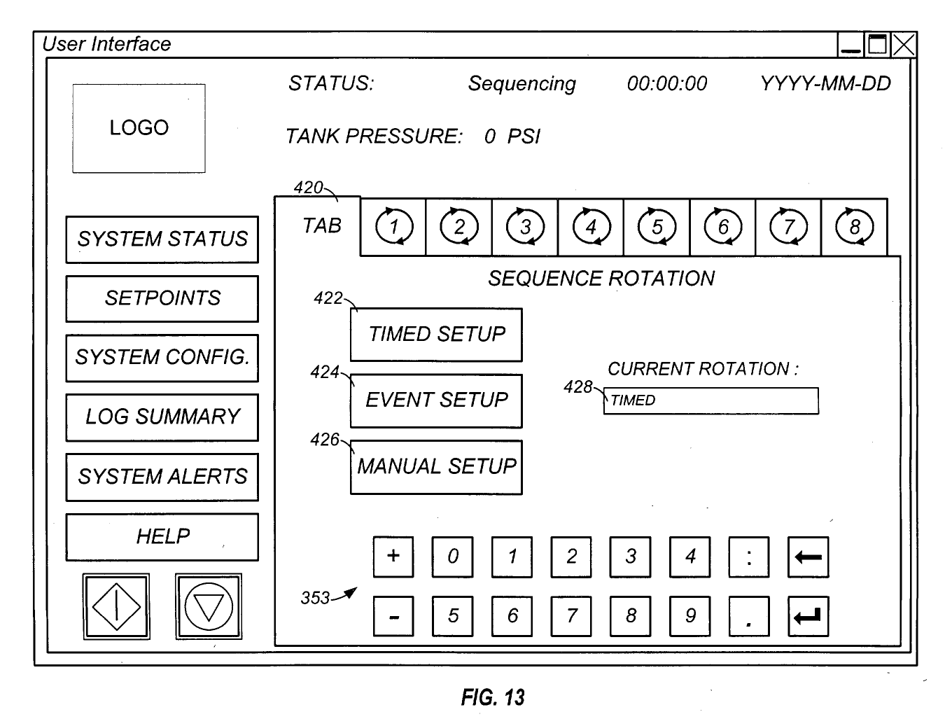

In one example, after defining the desired compressor 202 sequences, an operator may wish to setup an execution order for the sequences and thus select the sequence rotation button 370 (FIG. 9). FIG. 13 illustrates a resulting sequence rotation tab 420 that provides the user with a menu of setup options including a timed setup button 422, an event setup button 424, and a manual setup button 426. The rotation tab 420 also includes a field 428 indicating the currently selected mode of rotation, such as timed, event, or manual.

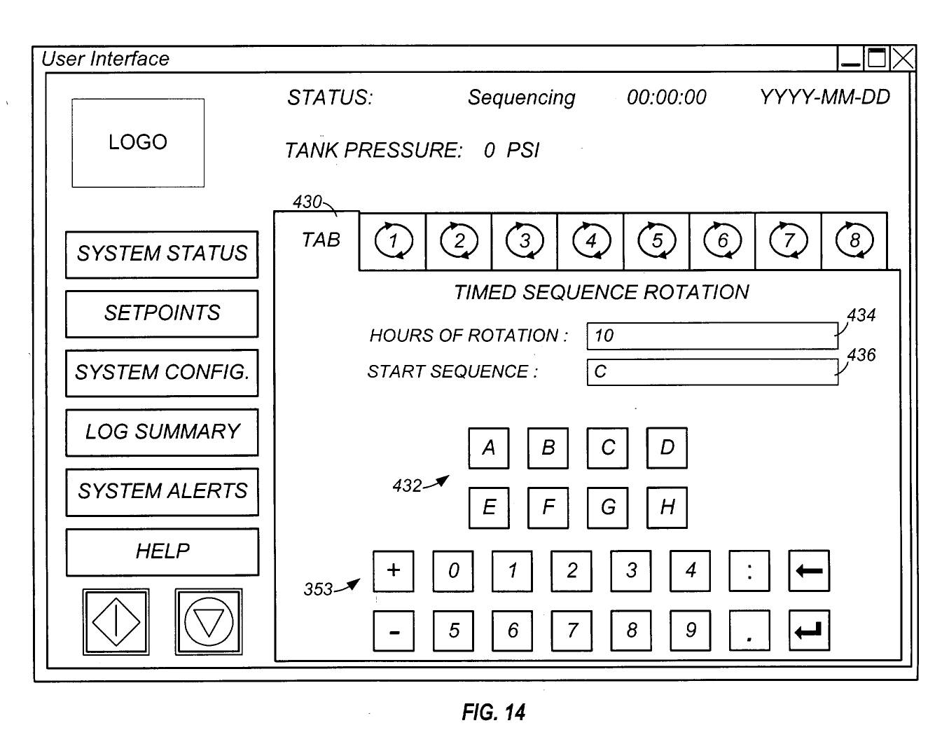

Selection of the timed setup button 422 presents the display of a tab 430 illustrated in FIG. 14. The tab 430 includes the graphical keypad 353, a sequence indicator keypad 432, a start-sequence field 434, and an hours-of-rotation field 436. In one embodiment, the operator may populate the fields 434 and 436 with a desired starting sequence and sequence duration, respectively. For example, starting with sequence C and a duration of 10 hours will result in sequence C operating for 10 hours followed by sequence D for 10 hours, and, if there is no defined sequence for indicators E, F, G, and H, the host controller 210 will skip to sequence A for 10 hours, then B, and so on. It should be noted that the sequence indicator keypad 432, and embodiments of the invention in general, may include more or less than the illustrated numbers of sequences.

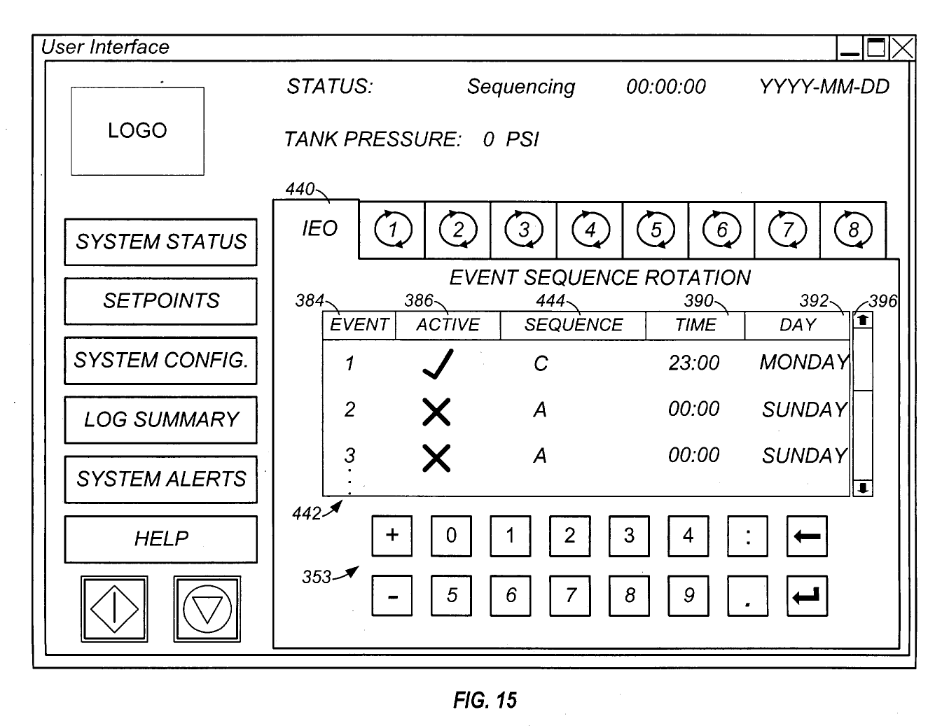

Selection of the event setup button 424 (FIG. 13) presents the display of a tab 440 illustrated in FIG. 15. The tab 440 includes the graphical keypad 353, a sequence window 442, and corresponding scroll bar 396. The sequence window 442 includes the event field 384, the active field 386, the time field 390, and the day field 392 similar to the setup window 382 (FIG. 10) with the addition of a sequence field 444. In one embodiment, the user may activate one or more events and enter the desired sequence, start time, and period for each event. Input to the time and day fields 390 and 392 may be such that the associated event is invoked daily, weekly, monthly, or the like.

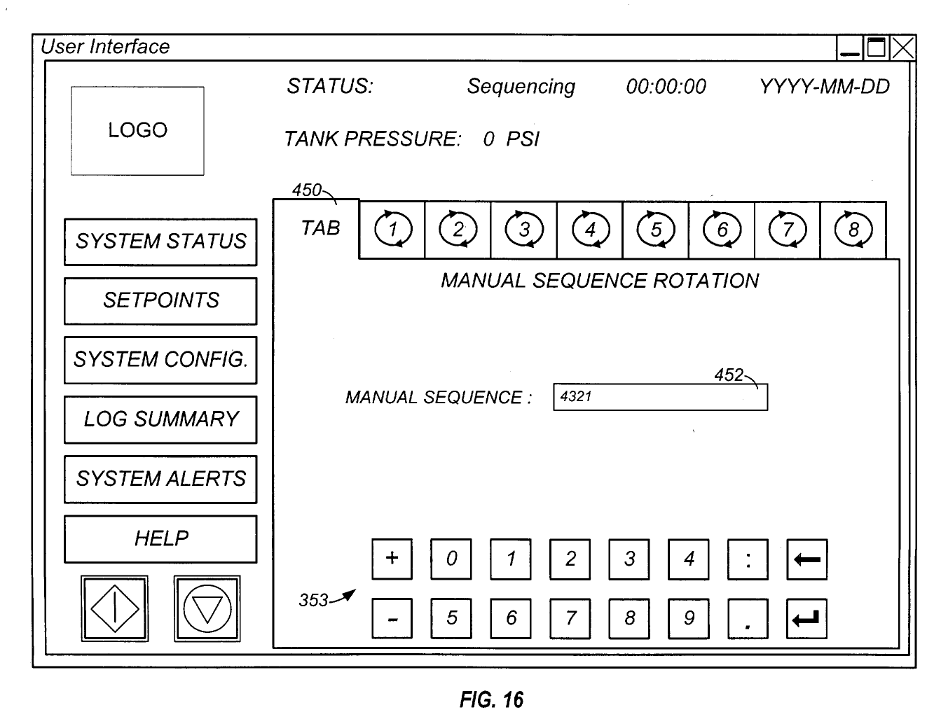

Selection of the manual setup button 426 (FIG. 13) presents the display of a tab 450 illustrated in FIG. 16. The tab 450 includes the graphical keypad 353 and a manual field 452. In one embodiment, selection of the manual setup button 426 allows the user to bypass any defined sequences or events and manually control the order of compressor 202 sequencing. For example, in a system having four compressors, the user may enter a desired sequence of 4, 3, 2, and 1. Upon pressing the enter button 358, the host controller 210 assumes control of loading and unloading the compressors and performs this activity according to the entered sequence.

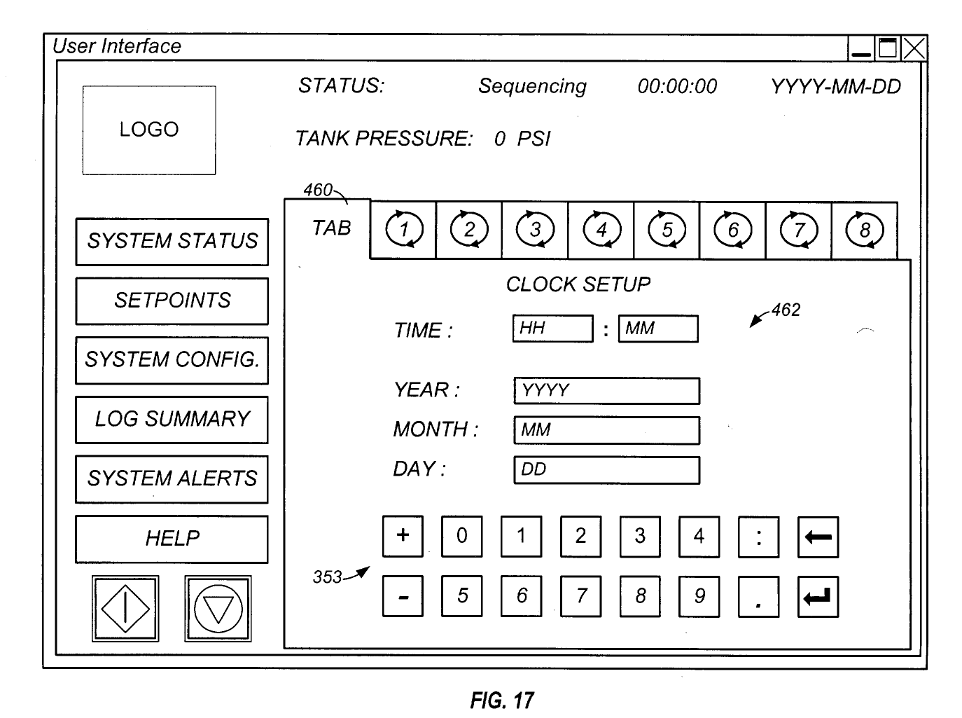

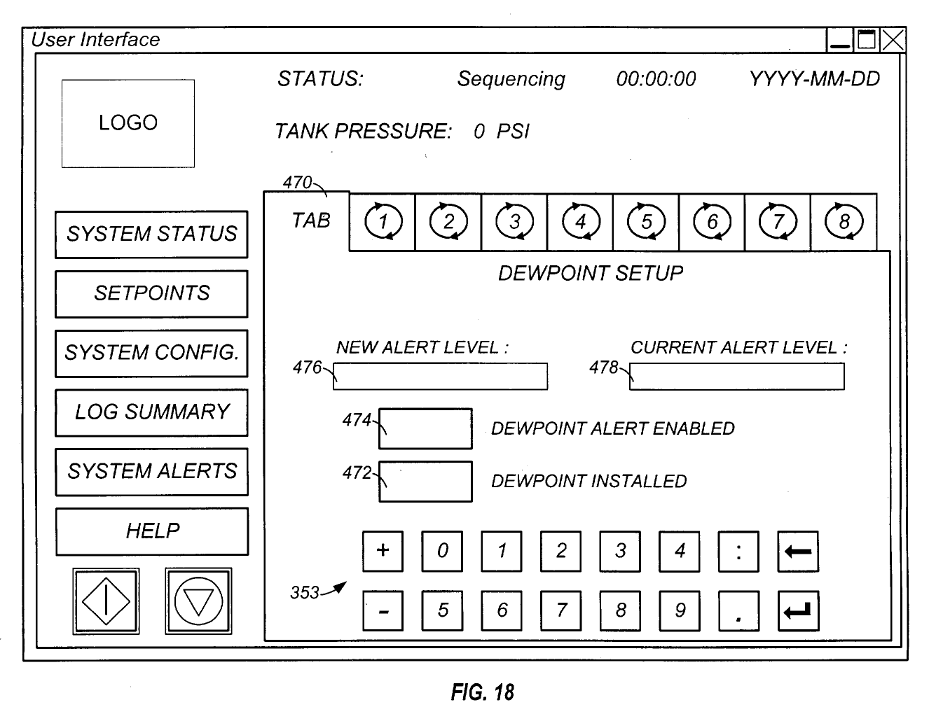

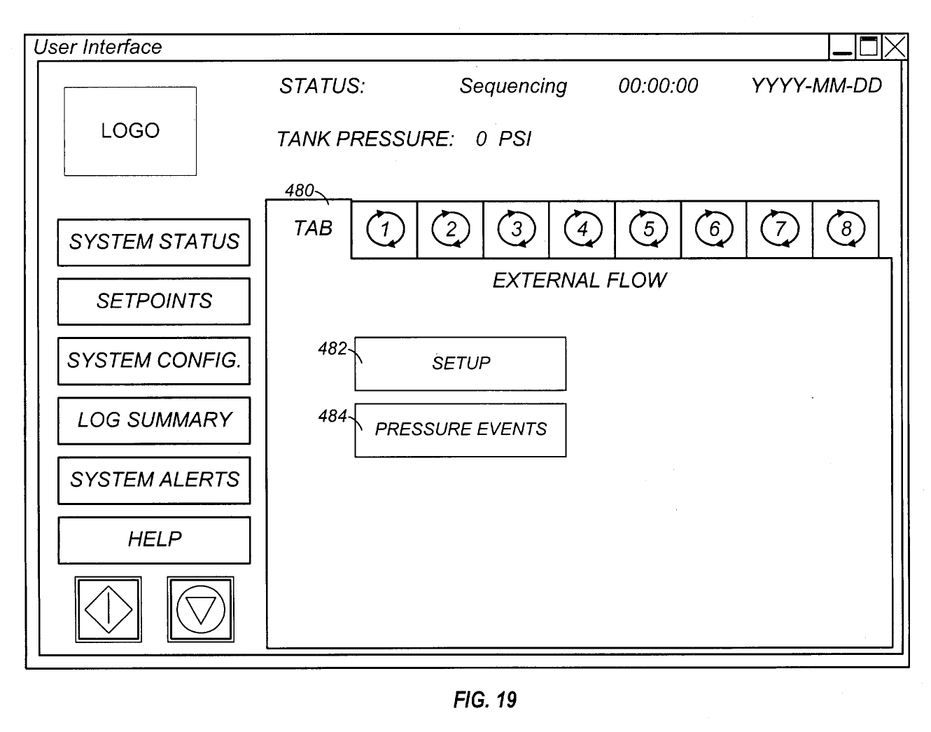

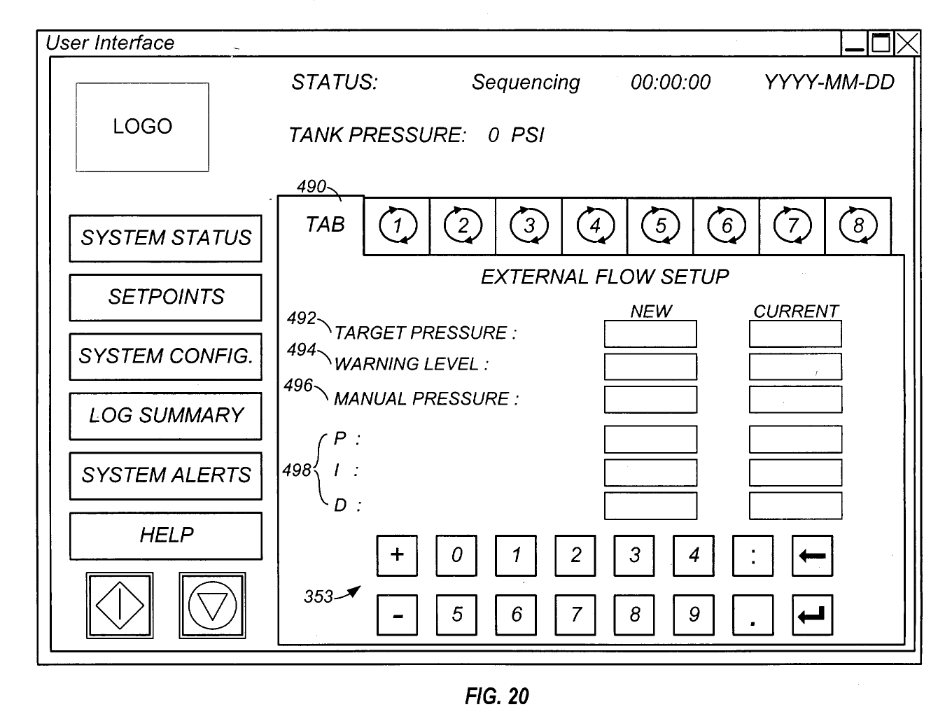

Referring to FIG. 9 selection of the clock setup button 372 yields a setup tab 460, illustrated in FIG. 17, including the graphical keypad 353 and input fields, shown generally at 462, for entering the current time and the date. Selection of the dew-point setup button 374 (FIG. 9) yields a dew-point tab 470, as illustrated in FIG. 18. The dew-point tab includes the graphical keypad 353, a dew-point installed button 472, an alert enable button 474, a new alert level field 476, and a current alert level field 478. In one embodiment, the user may select the dew-point installed button 472 to indicate that the system is equipped with the dew-point sensor 324 (FIG. 7) and enable the dew-point monitoring feature by selecting or activating the alert enable button 474. Once enabled, the host controller 210 monitors information received from the dew-point sensor 324 and alerts the user if the sensed dew-point exceeds the value entered in the current alert level field 478. A user may also change the alert level by populating the new alert level field 476. Selection of the external flow setup button 376 (FIG. 9) yields an external flow tab 480, as illustrated in FIG. 19, including a setup button 482 and a pressure events button 484. As illustrated in FIG. 20, choosing the setup button 482 results in a flow setup tab 490 for passing input parameters to the optional external flow controller 326. The flow setup tab 490 may include current and new value fields for a target pressure 492, a warning pressure level 494, a manual pressure level 496, and proportional, integral, and derivative control values 498. In some embodiments, the host controller 210 may be coupled to the optional external flow controller 326 and operable to monitor pressure levels, administer warnings, and communicate user input control values.

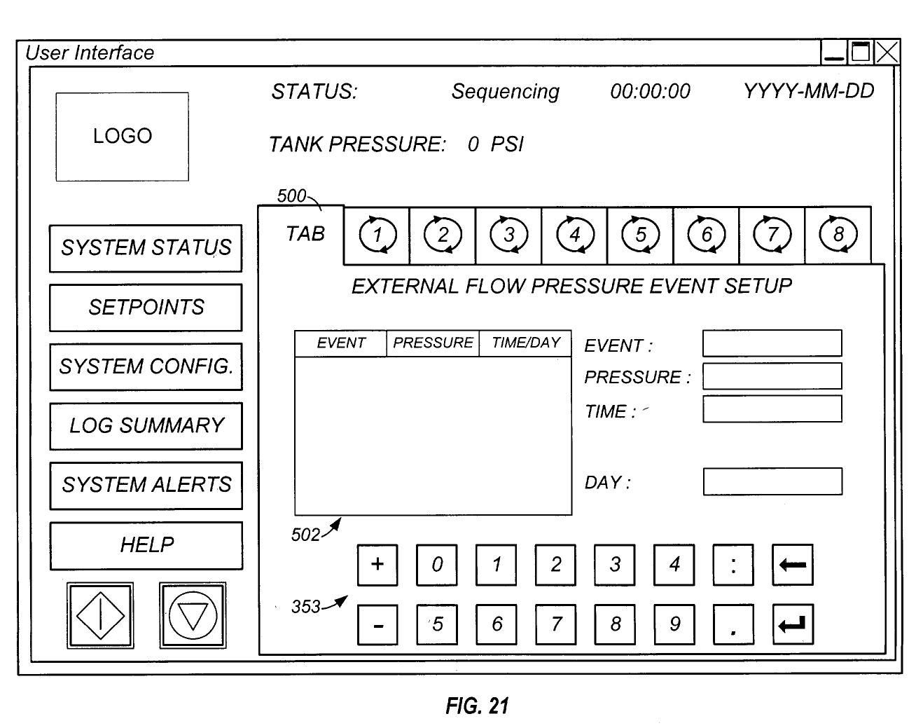

As illustrated in FIG. 21, choosing the pressure events button 484 (FIG. 19) yields an event setup tab 500 including the graphical keypad 353, a pressure event window 502, and one or more input fields.

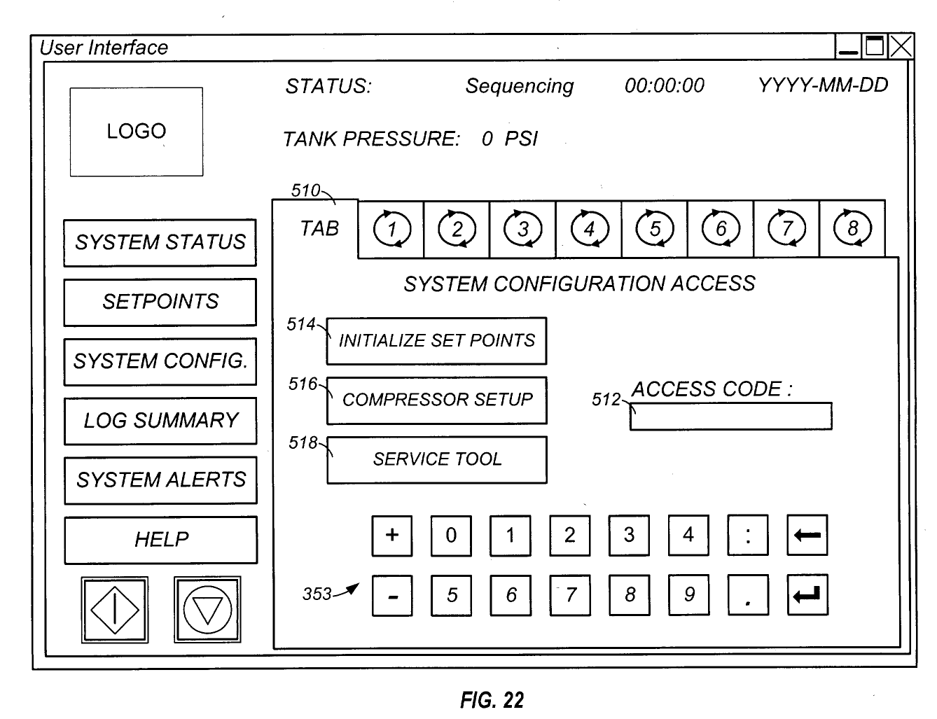

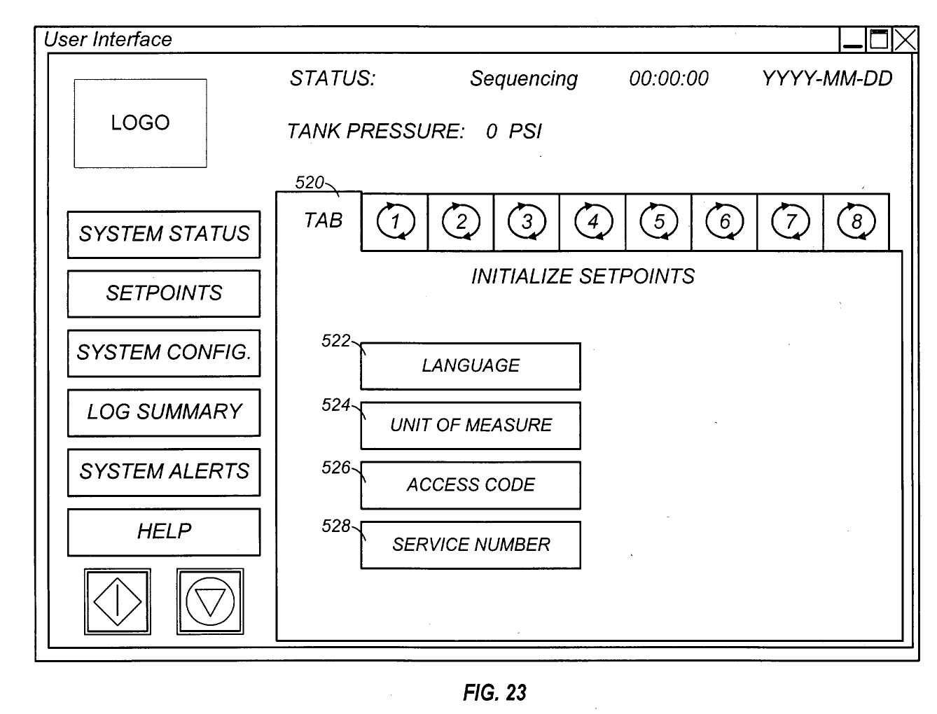

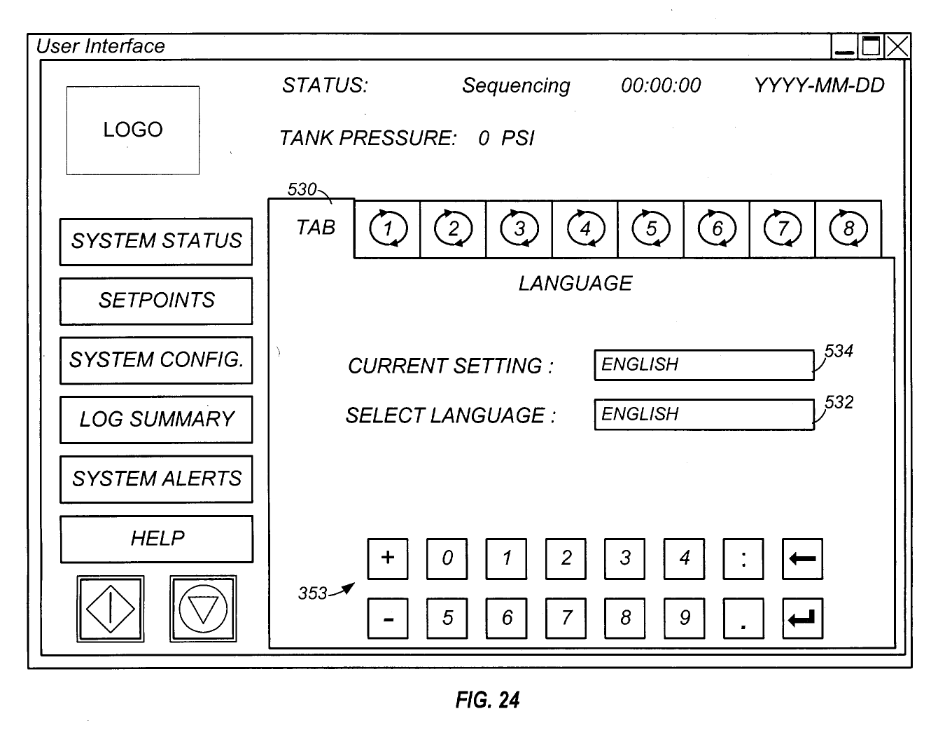

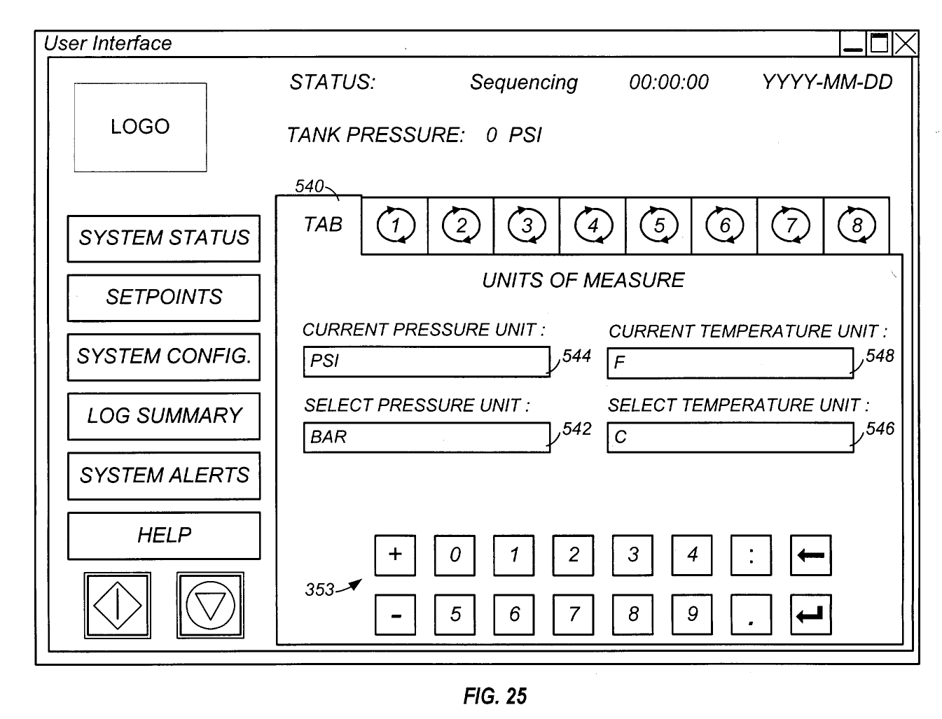

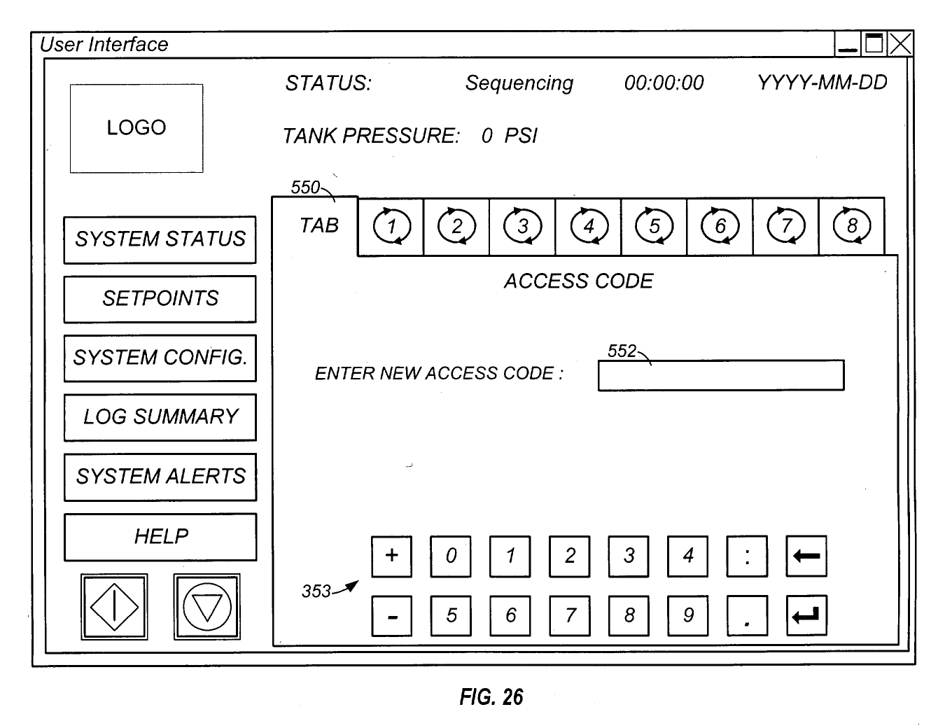

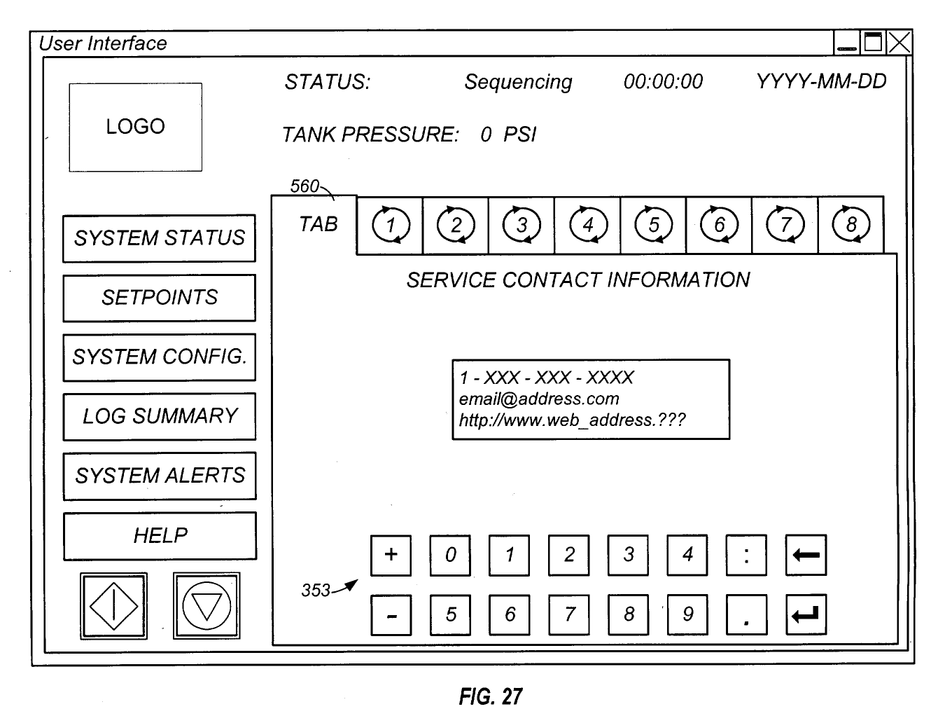

Referring to FIG. 7, the user may also select the above-described system configuration button 314, upon which an interface screen including an access tab 510, illustrated in FIG. 22, is presented to the user. The access tab 510 includes the graphical keypad 353, an access code field 512, an initialize set points button 514, a compressor setup button 516, and a service tool button 518. The access code field 512 may be used as a security measure similar to the access code field 352 of FIG. 9. The initialize set points button 514 is linked to an initialize tab 520 illustrated in FIG. 23. The initialize tab 520 includes a language button 522, a unit button 524, an access button 526, and a service button 528. Selection of the language button 522 presents the user with a language tab 530 shown in FIG. 24. The language tab 530 includes the graphical keypad 353, a select language field 532, and a current language field 534. The current language field 534 reflects what is entered in the select language field 532, which may include English or a variety of other languages. In at least one embodiment, the text associated with interface screens will be displayed in the selected language. Selection of the unit button 524 (FIG. 23) presents the user with a units-of-measure tab 540 shown in FIG. 25. The units-of-measure tab 540 includes graphical keypad 353, a select pressure unit field 542, a current pressure unit field 544, a select temperature unit field 546, and a current temperature unit field 548. In one embodiment, the current pressure unit field 544 and current temperature unit field 548 are operable to display the temperature and pressure measurement units, such as psi and ° F. respectively, that are currently active. The select pressure unit field 542 and select temperature unit field 546 are operable to accept user input for changing the displayed units. Changing the units of measure changes both the unit labels associated with the interface screens and also indicates to the host controller 210 and interface 216 that conversion operations may be required. The example illustrated in FIG. 25 includes exemplary units including psi and “bar.” However, other units are also possible such as kilopascals (“kPa”) and kilograms per square centimeter (“kg/cm²”). Selection of the, access button 526 (FIG. 23) presents the user with an access-code tab 550 shown in FIG. 26 that includes an input field 552 for entering a new access code. Embodiments of the invention that utilize the access code feature may use the input field 552 to define the code required for access to other interface screens and their associated functionality. Selection of the service button 528 presents a service phone number, email address, or other contact information on a service tab 560 shown in FIG. 27.

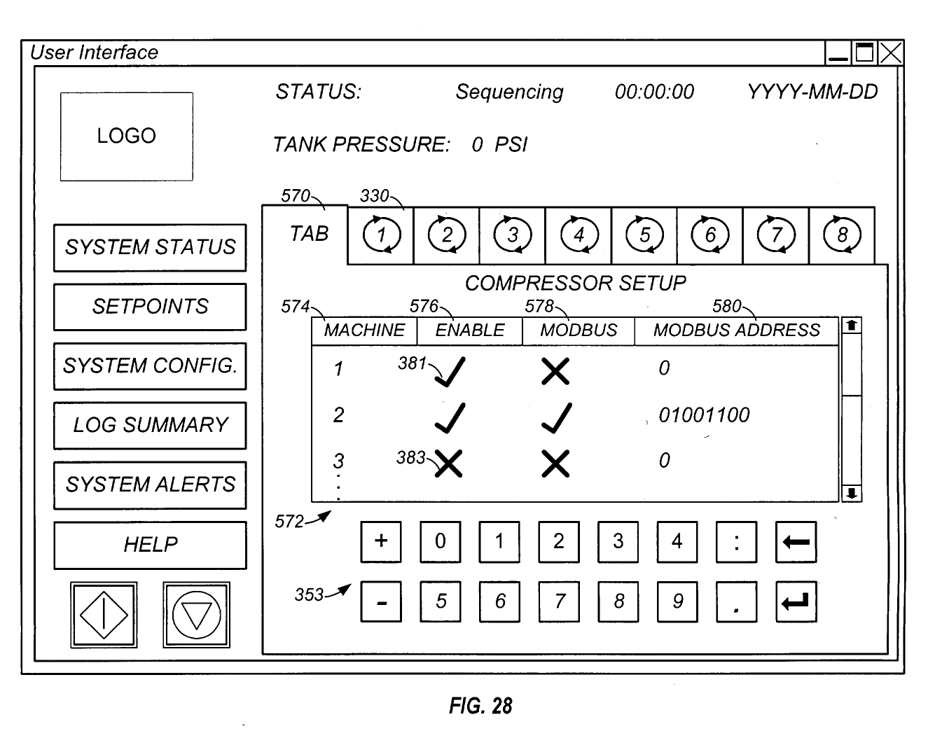

Referring again to FIG. 22, a user may also choose the compressor setup button 516 to access a setup screen or tab 570 shown in FIG. 28. In one embodiment, the tab 570 includes the graphical keypad 353 and a definition window 572 including a machine field 574, an enable field 576, a modbus field 578, and a modbus address field 580. In at least one embodiment, numbers listed in the machine field 574 correlate to compressors coupled to the host controller 210 and correspond with the compressor indicator tabs 330. The enable field 576 for each machine number may be toggled between an enabled and non-enabled state, which may be indicated by the check 381 and “X” 383 respectively. In some embodiments, the host controller 210 may be implemented to control compressors indirectly through network connections, other controllers, or a variety of other connections. As one example, a compressor 202 coupled to the host controller 210 by way of an external controller may require an address for establishing a communications link with that compressor. As shown for exemplary machine “2,” the modbus field 578 is enabled indicating that host controller 210 may communicate with the compressor 202 using the address input to the modbus address field 580.

In one embodiment, the transducer setup button 378 (FIG. 9), when selected, may present the user with one or more interface screens (not shown) operable to accept input from the user regarding the transducers (e.g., pressure sensors) in the system 200 and coupled to the host controller 210. As one example, the user may choose the transducer setup button 378 and manipulate the subsequent interface screens to indicate a transducer scaling or calibrate a no-load offset.

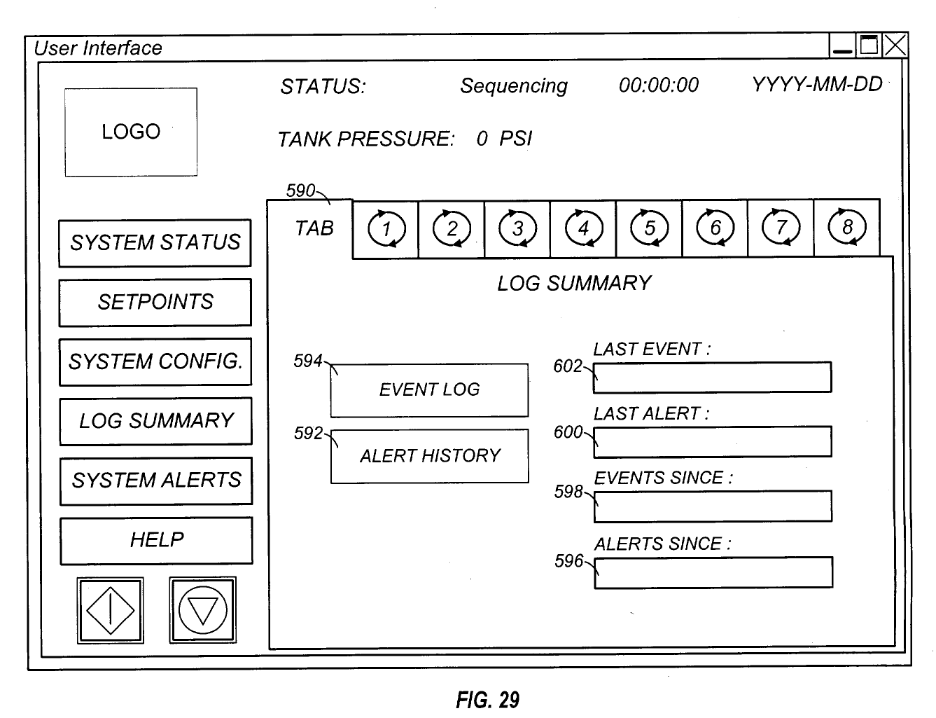

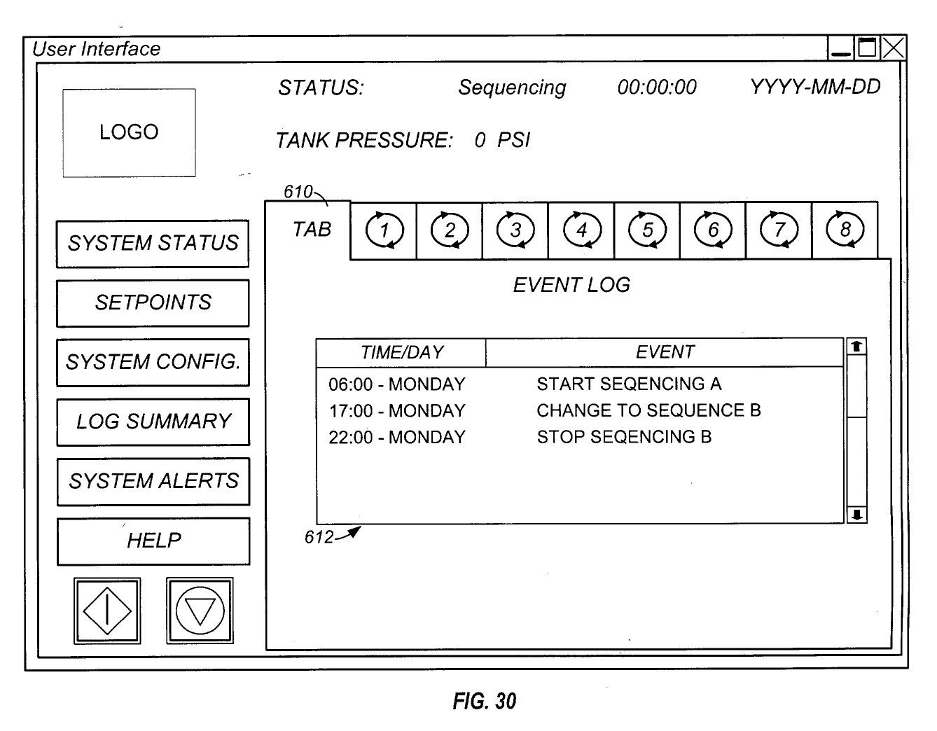

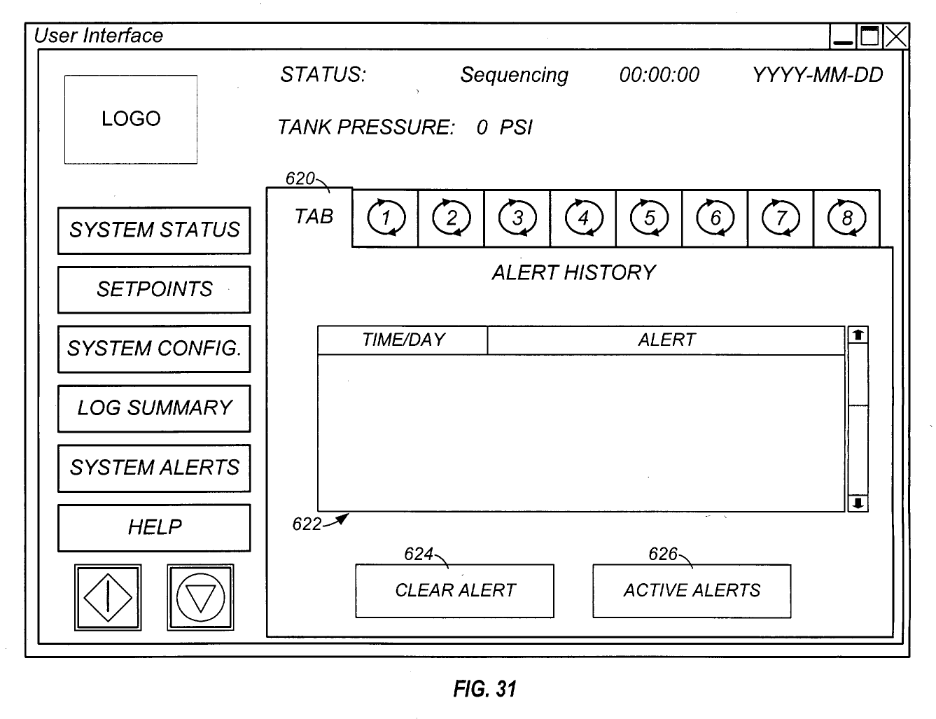

In some embodiments, the user may setup pressure and compressor 202 sequencing events according to a desired operating configuration and may also set warnings or alerts for various attributes, such as pressure, temperature, compressor 202 operating condition, dew-point, and others. In some instances, a user may desire to view the events and alerts that have previously occurred. FIG. 29 illustrates an exemplary interface screen for selection of the log summary button 315 including a summary tab 590. The summary tab 590 includes an alert history button 592, an event log button 594, an alerts since field 596, an events since field 598, a last alert field 600, and a last event field 602. In one embodiment, a user may choose the event log button 594 or the alert history button 592 to view what has previously occurred in the system 200 and each button and 592 are linked with exemplary interface screens illustrated in FIGS. 30 and 31, respectively. The fields 596 and 598 may be implemented to allow a user to query the event log and alert history in order to extract a subset of information. For example, the user may enter a particular date or time in the events since field 598. The interface 216 is operable to display all the events that the host controller 210 logged subsequent to that date or time. In addition, the interface 216 is also operable to display the most recent logged alert and event in the last alert field 600 and last event field 602, respectively. In some embodiments, interface with the summary tab 590 may be implemented for locating system weaknesses, determining system performance, or determining maintenance needs, such as replacing or calibrating components of the system 200.

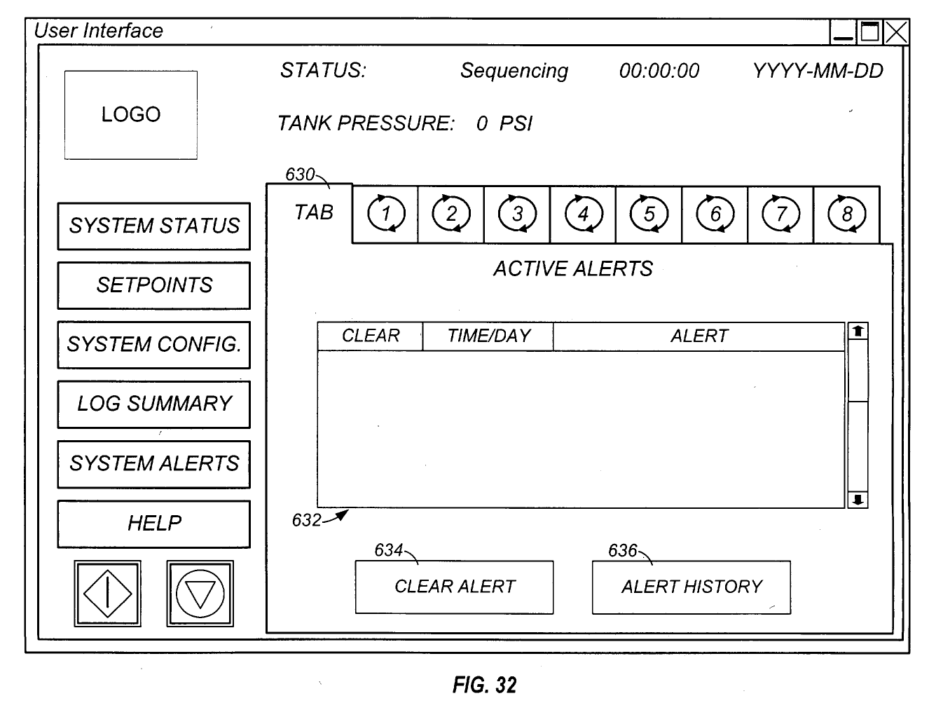

As noted above, FIGS. 30 and 31 illustrate exemplary interface screens used for displaying logged information. More specifically, FIG. 30 includes a log tab 610 with a scrollable log window 612. In some embodiments, both selecting the event log button 594 and entering a date or time into the events since field 598 (FIG. 29) will initiate the display of the log tab 610. Examples of events that may be logged include a sequence start or stop event, a change in sequence, a change in pressure, or many others. FIG. 31 illustrates an exemplary display of a history tab 620 and a scrollable alert window 622 for displaying alerts or alarms that have been logged. Similar to the display of FIG. 30, both selecting the alert history button 592 and entering a date or time into the alerts since field 596 (FIG. 29) initiates display of the history tab 620. Also included in the history tab 620 is a clear alert button 624 and an active alerts button 626. In one embodiment, the user may select an alert displayed in the alert window 622 and then clear or remove that alert by selecting the clear alert button 624. In addition, the user may select the active alerts button 626 to view an active alerts tab 630 illustrated in FIG. 32. In one embodiment, the active alerts tab 630 includes a scrollable active alert window 632 for displaying the currently set or active alerts. Also included in the alerts tab 630 is a clear alert button 634, which may be implemented in a manner similar to the clear alert button 624 described above. An alert history button 636 that, when selected, causes the interface 216 to display the history tab illustrated in FIG. 31 is also included.

As can be seen from the above, one embodiment of the invention provides a system for controlling one or more compressors in a multiple compressor environment. Various features and aspects of the invention are set forth in the following claims.

What is claimed is:

1. A human machine interface for a pressure system having a processor and a display device, the interface operable to
display one or more interface screens including a graphical representation of a machine, a passage, a connection between the machine and the passage, a tank, a connection between the passage and the tank, and a tank output; display one or more system parameters including a current system pressure and a machine status; and allow user input for configuring machine operating sequence and pressure events.

2. The interface of claim 1, wherein the machine representation includes a numeric indicator.

3. The interface of claim 1, further comprising a first graphical indicator associated with the machine, and that is dynamic when the machine is operating.

4. The interface of claim 3, wherein the first graphical indicator is an arrow.

5. The interface of claim 3, wherein the first graphical indicator is a color.

6. The interface of claim 1, further comprising a second graphical indicator associated with the machine, and that is dynamic when the machine is producing an output into the passage.

7. The interface of claim 6, wherein the second graphical indicator is an arrow oriented along the representation of the connection between the output of the machine and the passage.

8. The interface of claim 6, wherein the second graphical indicator is a color.

9. The interface of claim 1, wherein the representations are components in a compressed air system.

10. The interface of claim 1, further comprising a graphical indication of an air pressure value provided at the output.

11. The interface of claim 10, further comprising a graphical indication of a dew point of the compressed air.

12. The interface of claim 1, wherein the processor is configured to operate with a graphical-user-interface-based operating system.

13. A pressure system having a human machine interface, the system comprising:
a drive operable to be coupled to one or more machines;
one or more sensors operable to sense pressure; and
a controller in communication with the human machine interface and operable to control an output of the machine;
wherein the human machine interface is operable to provide one more interface screens for displaying system information, and operable to receive user input.

14. The system of claim 13, wherein the system information includes sequence rotation information.

15. The system of claim 13, wherein the system information includes pressure setup information.

16. The system of claim 13, wherein the system information includes pressure control information.

17. The system of claim 13, wherein the system information includes security access information.

18. The system of claim 13, wherein the system information includes alarm information.

19. The system of claim 13, wherein the human machine interface is operable to allow the user to interact with the one more interface screens using a plurality of input devices.

20. The system of claim 13, wherein the human machine interface is configured to operate with either or both a Unix-based and a Windows-based operating system.

21. A human machine interface having one or more interface screens operable to be displayed on a display device; wherein the human machine interface is operable to receive information representative of a pressure, a start command, a stop command, a machine status, a system status, a system configuration, a system set-point, a system alert, and a summary.

22. The human machine interface of claim 21, wherein the information is received from both or either a controller and a user.

23. A pressure system having a human machine interface, the system comprising:
a drive operable to be coupled to one or more machines; and
a controller in communication with the human machine interface and operable to control an output of the machine;
wherein the human machine interface is operable to provide one more interface screens for displaying one or more graphical representations and system information; and operable to receive user input for programming a plurality of operating sequences for the one or more machines, the operating sequences being based on one of either a timed sequence, an event sequence, or a manual sequence.

24. The system of claim 23, wherein the human machine interface is operable to allow the user to interact with the one more interface screens using a plurality of input devices.

25. The system of claim 23, wherein the one or more graphical representations includes a numeric indicator.

26. The system of claim 23, wherein the one or more graphical representations includes a numeric indicator that is dynamic when the machine is operating.
